(19) United States
(12) Patent Application Publication
(10) Pub. No.: US 2008/0262859 A1
(43) Pub. Date: Oct. 23, 2008

(54) SYSTEMS AND METHODS FOR PROVIDING A VIDEO RESUME

(75) Inventors: CHYR-CHONG JOSEPH TING, SAN JOSE, CA (US); ADAM HYDER, LOS ALTOS, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: YAHOO! INC., SUNNYVALE, CA (US)

(21) Appl. No.: 11/738,114

(22) Filed: Apr. 20, 2007

(51) Int. Cl. G06Q 10/00

(52) U.S. Cl. 705/1

(57) ABSTRACT

Methods and systems of providing a video resume are disclosed. An indication of a video resume template that is preferred by the recruiter is received. The video resume template can be indicative of at least one required characteristic to be present in the video resume. A video resume is received from a jobseeker. The video resume received from the jobseeker is formatted in accordance with the video resume template. The video resume is provided to the recruiter.

### BACKGROUND

1. Field

The present disclosure relates to job listing services. In particular, it relates to systems and methods of providing video resumes of jobseekers on a computer network.

2. General Background

Job listing providers generally provide searchable databanks of job listings related to employment opportunities and openings. In the current generation of online job listing services, listing service providers provide job searching capabilities to jobseekers based on search keywords entered by the jobseeker. In addition, listing service providers allow recruiters to receive previously-submitted resumes of jobseekers. Conventional systems provide to recruiters with a text resume of the jobseeker.

### SUMMARY

In one aspect, there is a method of providing a video resume. An indication of a video resume template that is preferred by the recruiter is received. The video resume template can be indicative of at least one required characteristic to be present in the video resume. A video resume is received from a jobseeker. The video resume received from the jobseeker is formatted in accordance with the video resume template. The video resume is provided to the recruiter.

In a further aspect, metadata associated with at least one section of the video resume can be received. The metadata can describe the content of the at least one section of the video resume. In another aspect, the metadata can describe associated text from a resume of the jobseeker.

In a further aspect, the required characteristic to be present in the video resume is a video section in which the jobseeker answer a to a question posed by the recruiter, a video section in which the jobseeker describes work experience, a video section in which the jobseeker describes languages spoken, or the length of time of a specific section of the video resume.

In another aspect of the method, a hyperlink can be created in a text resume of the jobseeker such that the hyperlink can reference a section of the video resume.

In one aspect, there is a system for providing a video resume. The system can comprise a user interface module, a video processing module, and a video rendering module. The user interface module can receive from a recruiter an indication of a video resume template that is preferred by the recruiter. The video resume template can be indicative of at least one required characteristic to be present in the video resume. The video processing module can receive a video resume from a jobseeker. The video resume can be formatted in accordance with the video resume template. The video rendering module can provides the video resume to the recruiter.

In another aspect, there is a method of providing a video resume. A video resume that includes one or more sections is receiving from a jobseeker. Each of the sections of the video resume can contain metadata indicative of the content of the each of the sections. The video resume can be posted on a searchable database on a network. The searchable database can be searchable by recruiters.

In yet another aspect, there is a method of receiving a video resume. An indication that the jobseeker wants to provide a video resume in connection with a job listing posted by a recruiter can be received from a jobseeker. An indication of a video resume template that is preferred by the recruiter is provided to the jobseeker. The video resume template can be indicative of at least one required characteristic to be present in the video resume. One or more video clips are received from the jobseeker. Input is received from the jobseeker to order and format the one or more video clips so as to create the video resume in a manner such that the video resume is formatted in accordance with the video resume template. The video resume can be posted on a website in association with the job listing such that the recruiter can view the video resume through a computer network.

In yet another aspect, there is method of providing a video resume. An indication of a video resume template that is preferred by a recruiter is received from the recruiter. The video resume template can be indicative of at least one required characteristic to be present in the video resume. A user interface can be provided to a jobseeker. The user interface can be configured to facilitate the creation of the video resume in accordance with the video resume template. The video resume can be received from the jobseeker and provided to the recruiter.

In another aspect, there is a user interface for creating a video resume. The user interface can include a selection mechanism, an editing area, and a display area. The selection mechanism can allow a jobseeker to indicate the source of one or more video clips to be included as part of the video resume. The editing area can permit a jobseeker to create the video resume in accordance with a video resume template. The display area can permit a jobseeker to preview the video resume being created.

### DRAWINGS

The features and objects of alternate embodiments of the present disclosure will become more apparent with reference to the following description taken in conjunction with the accompanying drawings of various examples wherein like reference numerals denote like elements and in which:

FIG. 1 depicts a component diagram of a system for providing a video resume according to one embodiment.

FIG. 2 depicts a component diagram of a computing device according to one embodiment.

FIG. 3 depicts an exemplary user interface for posting a job listing according to one embodiment.

FIG. 4 depicts an exemplary user interface for establishing a template for a video resume according to one embodiment.

FIG. 5 depicts a flow diagram of a process for providing a video resume according to one embodiment.

FIG. 6 depicts an exemplary user interface for uploading a resume according to one embodiment.

FIG. 7 depicts an exemplary user interface for creating a video resume according to one embodiment.

FIG. 8 depicts an exemplary user interface for entering metadata information associated to a video resume according to one embodiment.

FIG. 9 depicts an exemplary user interface for permitting a recruiter to enter and submit a search for jobseekers according to one embodiment.

FIG. 10 depicts an exemplary user interface for listing jobseekers that have applied for a job listing posted by the recruiter according to one embodiment.

FIG. 11 depicts an exemplary user interface for displaying a video resume according to one embodiment.

### DETAILED DESCRIPTION

The system and method disclosed herein permits a recruiter to view video resumes submitted by jobseekers. Thus, recruiters can view qualifications and of a jobseeker. A video resume can be any type of digital audiovisual media content that can be rendered to a recruiter. Examples include digital videos that are delivered over the Internet in formats such as MPEG4, AVI, and the like. The video resume can be divided into sections. Sections of a video resume can correspond to specific topics that the jobseeker discusses related to his qualifications. Examples of sections within a video resume can be an education section, a work experience section, a skills section, and the like.

Recruiters can be provided with the ability to establish one or more video resume templates. Video resume template can include one or more required characteristics that the recruiter prefers to see in the video resume. Such required characteristics can vary according to the job listing, thus permitting jobseekers that are tailored to each employee and/or job listing. An example of a characteristic is a specific section that a recruiter would like to see in the video resume. For instance, a recruiter can require that all video resumes submitted must include a fun fact section in which a jobseeker discusses a fun fact about the jobseeker. The required characteristic can be anything related to the type, amount, quality, or quantity of the content, format, and/or presentation of the video resume.

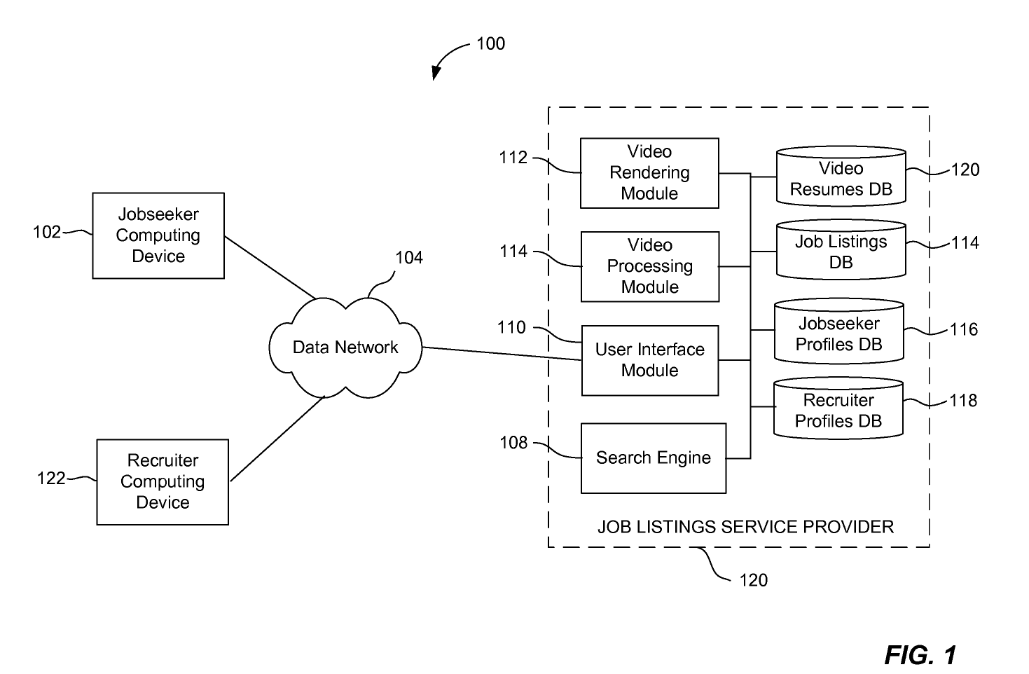

FIG. 1 depicts a component diagram of a system for providing a video resume according to one embodiment. In one embodiment, the job listing service provider 120 can host an online service of listing, posting and searching jobs. As such the job listing service provider 120 can be a business entity that owns and operates a computer infrastructure connected to a data network in order to provide a job listing service.

Jobseekers can access the services provided by the job listing service provider 120 via a data network 104. In one embodiment, the data network 104 is the Internet. In another embodiment, the data network 104 is an intranet. A jobseeker can utilize a jobseeker computing device 102 to communicate via the data network 104 with one or more computing modules and or services that are part of the computer infrastructure managed by the job listing service provider 120. In addition, a recruiter can utilize a recruiter computing device 122 to communicate via the data network 104 with one or more computing modules and or services that are part of the computer infrastructure managed by the job listing service provider 120.

In one embodiment, a user interface module 110 can be included as part of the computer infrastructure operated by the listing service provider 120. The user interface module 110 can be configured with logic to communicate with the jobseeker computing device 102 by sending and receiving data. Likewise, the user interface module 110 can be configured with logic to communicate with the recruiter computing device 122 by sending and receiving data.

In addition, in one embodiment, the user interface module 110 is configured to receive job search requests from the jobseeker computing device 102. The job search requests can include parameters entered by the jobseeker such as location, title, and salary of a job listing. In another embodiment, the user interface module 110 can be configured to receive an indication from the jobseeker that the jobseeker is interested in a job from the set of job listings. For example, the indication can be submission of the resume of the jobseeker, the submission of personal data, checking a checkbox in a user interface that indicates that the user would like to apply for a particular job listing, etc.

In another embodiment, the user interface module 110 can be configured to receive a jobseeker search request from a recruiter. The jobseeker search request submitted by a recruiter to search for one or more jobseekers that match the criteria established by the recruiter.

In another embodiment, the user interface module 110 can be further configured to receive an indication from the recruiter that the recruiter is interested in a jobseeker. The indication can be for example a request to download or otherwise obtain a video resume of the jobseeker.

In another embodiment, the user interface module 110 can be further configured to receive and/or process template information for a video resume as established by a recruiter. Thus, the user interface module 110 can receive from a recruiter an indication of a video resume template that is preferred by the recruiter. The indication of the video resume template can be representative of the recruiter preferences of the content and form of the video resume. In one embodiment, the video resume template can be indicative of at least one required characteristic to be present in the video resume. For example, the recruiter can require that the video include at least a five-minute section of the jobseeker speaking French. In another example, if the job listing is for a dancing company, the recruiter can require that the video include a dance demonstration of the jobseeker. In another example, if the job listing is for a receptionist, the recruiter can require that the video include one minute demonstration of how the jobseeker would handle walk-in customer.

The user interface module 110 can be configured with graphical user interface items to use tools for creating, editing, and/or manipulating one or more video resumes. Thus, the user interface module 110 can also be configured with logic to permit a jobseeker to select the video source or video sources to select video clips. In addition, the user interface module 110 can be configured to interact with a video processing module 114.

The user interface module 110 can be configured with graphical user interface items to use tools for interacting with the display, rendering, searching, and/or manipulating playback of one or more video resumes. The user interface module 110 can interface with a video rendering module 112 in order to display rendered video, transmit playback commands, etc. As such, the user interface module 110 can include user input mechanisms to select the playing, stopping, rewinding, pausing or fast forwarding of a video resume. In another example, the user interface module 110 can be configured to permit a recruiter to select specific sections of a vide resume and view the selected section. In addition, the user interface module 110 can also include commands for maximizing the display of the playing video, minimizing the display of the playing video, and the like.

The user interface module 110 can be further configured with logic to operate video playback and display. In yet another example, a user can utilize a mouse pointer to double click on a video display region in order to change the size of the video display region. Furthermore, the user interface module 110 can also permit a user to rewind and view a portion of the video. The video can be buffered and saved in a memory module in order to permit later viewing of the video, pausing and resuming the viewing of the video, etc.

In one embodiment, the video rendering module 112 can be configured with logic to receive video signals and transcode the video signals into a format that compatible with the recruiter computing device 122. In a further embodiment, the video rendering module 112 can also be configured with logic to operate video playback. For example, the video rendering module 112 can be configured with a play operation, a stop operation, a fast forward operation, a pause operation and/or a rewind operation. Based on user input or another module's input, the video rendering module 112 can execute any one of these operations when playing video. In addition, the video rendering module 112 can also be configured with logic to display data associated with the video clip, for example, the jobseeker text associated with a section of the video resume. In another example, the video rendering module 112 can also be configured with logic to display sections of the video resume according to jobseeker selection.

Furthermore, the video rendering module 112 can also be configured to playback video content while the user interacts with the user interface and/or the queuing module 308.

In addition, the video rendering module 112 can be configured to buffer video input received from one or more video sources. The buffered video can correspond to live streams, or any other type of video that is streamed to the computing device 102. As part of the buffering operation, the video can be stored in a hard drive, cache, random access memory, or any other memory module coupled with the computing device 102.

In yet another embodiment, the video rendering module 112 can be configured with logic to display the played video as a full screen display or as any other size required by a user. Furthermore, the video rendering module 112 can also include audio control commands and operations that a user can utilize to control both the visual display and the accompanying audio portion, if any.

In one embodiment, a video processing module 114 can be configured with logic to permit a jobseeker to create a video resume. In one embodiment, the video processing module 114 can allow a jobseeker to upload various video clips. For example, the jobseeker can upload a media file containing a video clip. In another example, the jobseeker can indicate the network address of a video file on a network location via the data network 104. Furthermore, the video processing module 114 includes logic to interact with the user interface module 110 and permit the jobseeker to order, edit, and/or manipulate the various video clips of the jobseeker.

In one embodiment, the video processing module 114 is configured to prevent the jobseeker from altering the content of the video clips such that the content is unaltered. In yet another embodiment, the video processing module 114 can be configured to work directly with a video recording module (not shown) and a camera (not shown) at the jobseeker computing device 102. The video recording module and the camera can be configured to interact with the video processing module 114 in order to transmit unaltered video clips recorded by the jobseeker.

In another embodiment, the video processing module 114 is configured with logic to permit a jobseeker to organize video clips and compile a video resume. Various video clips can be joined together in order to construct different sections of a video resume. The video processing module 114 can be configured to attach metadata to one or more sections of the video resume. The metadata can be tags, keywords, and the like. In addition, each section of the video resume can be created to be directly accessible (e.g., without having to view linearly previous sections of the video resume).

In another embodiment, the video processing module 114 can be configured with logic to create a menu of sections of the video resume. In another embodiment, the video processing module 114 is configured with logic to check the video resume for conformance with the video resume template provided by the recruiter. In yet another embodiment, the video processing module 114 is configured with logic to preview the video resume and sections of the video resume. In another embodiment, the video processing module 114 is configured with logic to permit the editing, manipulation of sections of the video resume, etc.

In one embodiment, the video processing module 114 can further be configured to store video resumes at a video resumes database 120. The video resumes database 120 can by any type of data repository that can be searched and accessed to retrieve data such as the video content of each video resume.

In another embodiment, a search engine 108 can be included as part of the computer infrastructure operated by the listing service provider 120. The search engine 108 can communicate with a job listings database 114 to store and retrieve job listing data. The job listing data stored at the job listings database 114 can include video resume template information for a specific job listing. Thus, as explained above, depending on the job requisites, the recruiter may require that certain characteristic be included in the video resume. Characteristics required to be in the video resume may include demonstration of a specific skill, duration of a section in the video resume, answers to specific questions provided by the recruiter, and any other information on the jobseeker or configuration of the video resume that the recruiter deems necessary.

Furthermore, the search engine 108 can also communicate with a jobseeker profiles database 116 to store and retrieve jobseeker's profiles. For example, jobseeker qualifications, jobseeker resume, personal data, contact information, etc., can be stored at the jobseeker profiles database 116. In addition, a default video resume, or a pointer to a video resume in the video resumes database 120, can be stored as part of the jobseeker profile.

In addition, the search engine 108 can also communicate with a recruiter profiles database 118 to store and retrieve recruiter's profiles data. For example, the set of requisites can include listed jobs, requisites for listed jobs, contact information, company data and information, etc. In another example, the recruiter profile can include a default video resume template.

In one embodiment, searches by a jobseeker can be received at the search engine 108. Jobseeker queries can be received at a search engine 108. In one embodiment, the search engine 108 is configured with logic to determine whether the search words submitted by the jobseeker match any job listing descriptions as stored in the job listings database 106. For example, job listings can have metadata such as job title, location, surrounding areas, salary, associated keywords, employer name, identifiers, job affinity information, etc. The search engine 108 can be configured to compare each of these pieces of data against search words used by the jobseeker.

Thus, the search engine 108 is configured to search a job listing database 114 to identify a set of jobs listings having associated metadata that match the search criteria received from the jobseeker.

In another embodiment, searches by a recruiter can be received at the search engine 108. The search engine 108 can be configured to search the jobseeker profiles database 116 to identify a set of jobseekers having associated metadata that match a search criteria received from the recruiter. In addition, the search engine 108 can further be configured to search the video resumes database 120. In one example, the search engine 108 can search through the metadata associated with each of the video resumes. Upon finding a minimum number search terms in the metadata, the video resume can be returned as a result. The recruiter can then review the video resume and navigate through the sections of the video that have associated metadata relevant of the search of the recruiter.

While various databases have described herein, one skilled in the art will recognize that each of the aforementioned databases can be combined into one or more data repositories, and be located either locally or remotely. In addition, each of the aforementioned databases can be any type of data repository configured to store data and can be implemented using any methods of storage now known or to become known. Likewise, while various modules have described herein, one skilled in the art will recognize that each of the aforementioned modules can be combined into one or more modules, and be located either locally or remotely. Each of these modules can exist as a component of a computer program or process, or be standalone computer programs or processes recorded in a data repository.

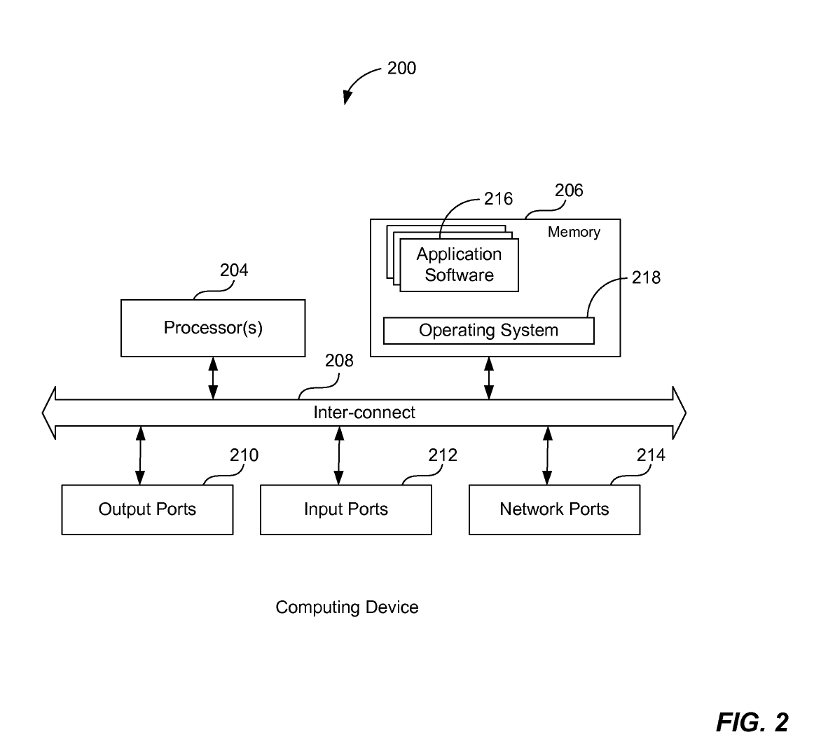

FIG. 2 depicts a component diagram of a computing device according to one embodiment. The computing device 200 can be utilized to implement one or more computing devices, computer processes, or software modules described herein. In one example, the computing device 200 can be utilized to process calculations, execute instructions, receive and transmit digital signals, as required by the jobseeker computing device 102. In another example, the computing device 200 can be utilized to process calculations, execute instructions, receive and transmit digital signals, receive and transmit search queries, job listings, and hypertext, as required by the relevance module 107, the search engine 108, the user interface module 110 and the accounting module 112.

The computing device 200 can be any general or special purpose computer now known or to become known capable of performing the steps and/or performing the functions described herein, either in software, hardware, firmware, or a combination thereof.

The computing device 200 includes an inter-connect 208 (e.g., bus and system core logic), which interconnects a microprocessor(s) 204 and memory 206. The inter-connect 208 interconnects the microprocessor(s) 204 and the memory 206 together. Furthermore, the interconnect 208 interconnects the microprocessor 204 and the memory 206 to peripheral devices such input ports 212 and output ports 210. Input ports 212 and output ports 210 can communicate with I/O devices such as mice, keyboards, modems, network interfaces, printers, scanners, video cameras and other devices. In addition, the output port 210 can further communicate with the display 104.

Furthermore, the interconnect 208 may include one or more buses connected to one another through various bridges, controllers and/or adapters. In one embodiment, input ports 212 and output ports 210 can include a USB (Universal Serial Bus) adapter for controlling USB peripherals, and/or an IEEE-1394 bus adapter for controlling IEEE-1394 peripherals. The inter-connect 208 can also include a network connection 214.

The memory 206 may include ROM (Read Only Memory), and volatile RAM (Random Access Memory) and non-volatile memory, such as hard drive, flash memory, etc. Volatile RAM is typically implemented as dynamic RAM (DRAM), which requires power continually in order to refresh or maintain the data in the memory. Non-volatile memory is typically a magnetic hard drive, flash memory, a magnetic optical drive, or an optical drive (e.g., a DVD RAM), or other type of memory system which maintains data even after power is removed from the system. The non-volatile memory may also be a random access memory.

The memory 206 can be a local device coupled directly to the rest of the components in the data processing system. A non-volatile memory that is remote from the system, such as a network storage device coupled to the data processing system through a network interface such as a modem or Ethernet interface, can also be used. The instructions to control the arrangement of a file structure may be stored in memory 206 or obtained through input ports 212 and output ports 210.

In general, routines executed to implement one or more embodiments may be implemented as part of an operating system 218 or a specific application, component, program, object, module or sequence of instructions referred to as application software 216. The application software 216 typically can comprises one or more instruction sets that can be executed by the microprocessor 204 to perform operations necessary to execute elements involving the various aspects of the methods and systems as described herein. For example, the application software 216 can include video decoding, rendering and manipulation logic.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions may be embodied in digital and analog communication links for electrical, optical, acoustical or other forms of propagated signals, such as carrier waves, infrared signals, digital signals, etc.

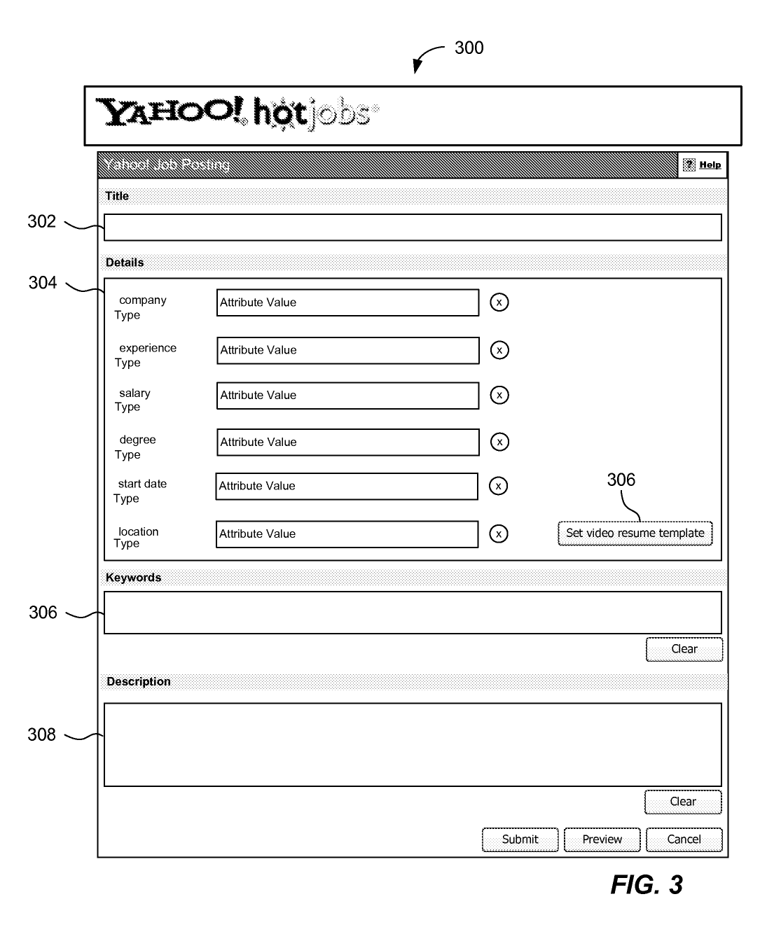

FIG. 3 depicts an exemplary user interface for posting a job listing according to one embodiment. The user interface 300 can be provided by the job listing service provider 120. A recruiter such as an employer can enter a new job listing in the user interface 300 which can later be displayed at the website of the job listing service provider 120. A title field 302 can be provided to enter a title or designation for the job listing. Attribute fields 304 can be provided for entering further information regarding the listing being entered. For example, for a job listing, attributes that can be entered in the attribute fields 304 include company, experience, salary, degree, start date, location, etc. In addition, a keyword field 306 and a description field 308 can also be provided to the recruiter in order to further qualify and/or describe the listed job.

Furthermore, a button 310 can be provided to permit the recruiter to select to enter a video resume template. As mentioned previously, the video resume template can include requirements of various characteristics of the video resume, such as content, format, length, organization, etc.

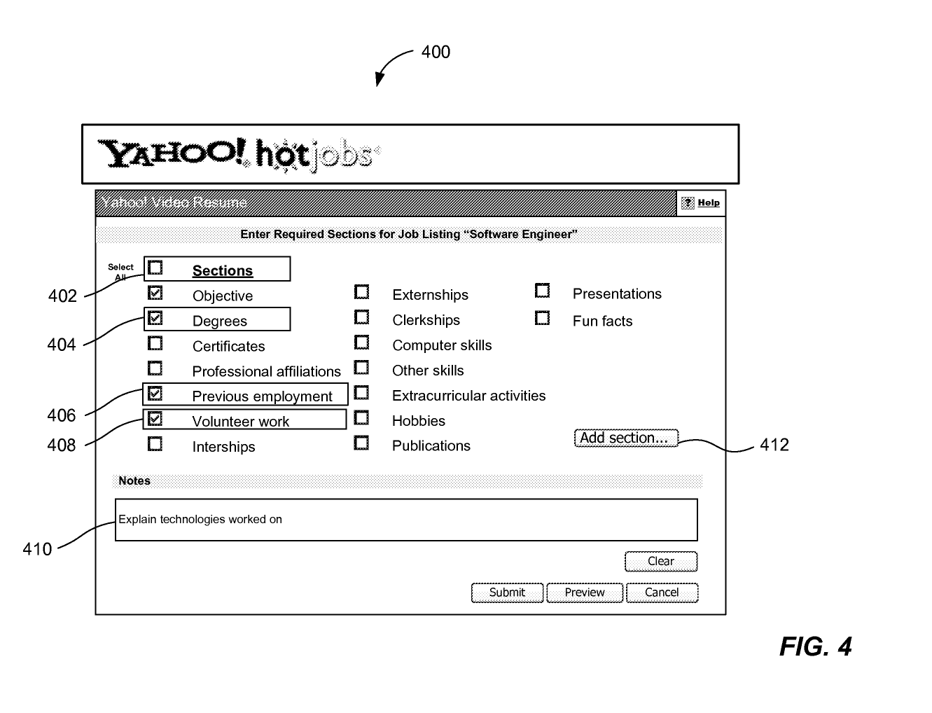

FIG. 4 depicts an exemplary user interface for entering a video resume template according to one embodiment. User interface 400 can be provided as part of a website of the job listings service provider 120. In one embodiment, the user interface 400 can be provided to the recruiter once the recruiter selects button 306 when entering a new job posting. Thus, for example, at the time of posting a job listing, the recruiter can select to set a video resume template for that specific job listing being posted. In one example, the user interface 400 can allow a recruiter to select the sections of a video resume required by the recruiter. Thus for example, user interface 400 can show one or more checkboxes corresponding to various sections that the recruiter would like to see in a video resume. In one example, if the recruiter selects all sections shown in the user interface 400, the user can select checkbox 402. In another example, if the recruiter would like to require that as part of the video resume a section where the jobseeker discusses Degrees, the recruiter can check checkbox 404. In that example, the jobseeker can provide a video clip of the jobseeker explaining the various degrees that the jobseeker holds. Likewise, in another example, the recruiter can require that a video clip or a section of the video resume be included for previous employment. To do this, the recruiter can select the checkbox 406. Likewise, if the recruiter would like to hear and know more about the jobseeker's past volunteer work, the recruiter can check the checkbox 408. In the same fashion, the recruiter can select any other checkboxes shown in user interface 400 in order to require jobseekers applying for the job listing associated with user interface 400.

Furthermore, a recruiter can add custom sections as part of the requirements for a video resume. To do this, the recruiter can select the button 412 and enter the label of the custom section and the specific requirements of that section.

In another embodiment, the recruiter can enter related notes associated with the resume template. In one example, the recruiter can enter notes in a text field 408. The notes can be provided as a guide to jobseekers for recording the film and including further content and characteristics required by the recruiter. As illustrated in user interface 400, a recruiter has entered a requirement to include an explanation of various technologies that the jobseeker worked on. Allowing recruiters to enter additional notes and requirements can be very beneficial for a more tailored and custom video resume that employers and recruiters can utilize in order to screen jobseekers. Of course, the user interface 400 can have various other user interface elements that can permit the recruiter to further enter required characteristics of video resumes.

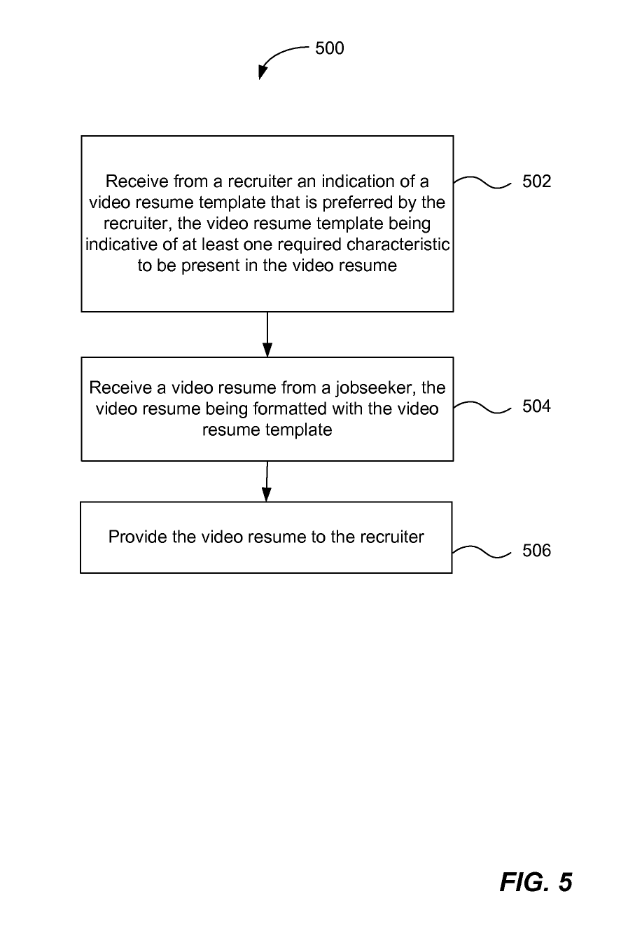

FIG. 5 depicts a flow diagram of a process for providing a video resume according to one embodiment. At process block 502, an indication is received from a recruiter of a video resume template that is preferred by the recruiter. A video resume template can be indicative of at least one required characteristic to be present in the video resume. Required characteristics can include a performance demonstration of showing of a specific skill or an explanation of such skill. All the characteristics required can, for example, be the specific length of a video resume. Thus, if the recruiter wants very short snippet of the jobseeker, the recruiter can limit the video resume to a fifteen-second video resume in which the jobseeker can simply state his name, occupation and a fun fact about the jobseeker. Many other characteristics can be provided by the recruiter such that the video resume submitted by each jobseeker comports with the requirements of recruiters and provide recruiters useful information to select potential employees. Process 500 continues at process block 504.

At process block 504, a video resume is received by a jobseeker. The video resume can be created to include the at least one required characteristic provided by the recruiter. As such, the video resume can be formatted in accordance with the video resume template. Process 500 continues at process block 506.

At process block 506, the video resume is provided to the recruiter. In one embodiment, the video resume can be provided to the recruiter by streaming the video content over the video network 104 to the recruiter computing device 102. In another example, the video resume can be provided to the recruiter by submitting to the recruiter a link for a network address that the recruiter can access to view the video resume. In yet another example, the video resume can be recorded on a digital video disk (DVD) and submitted or mailed to the recruiter.

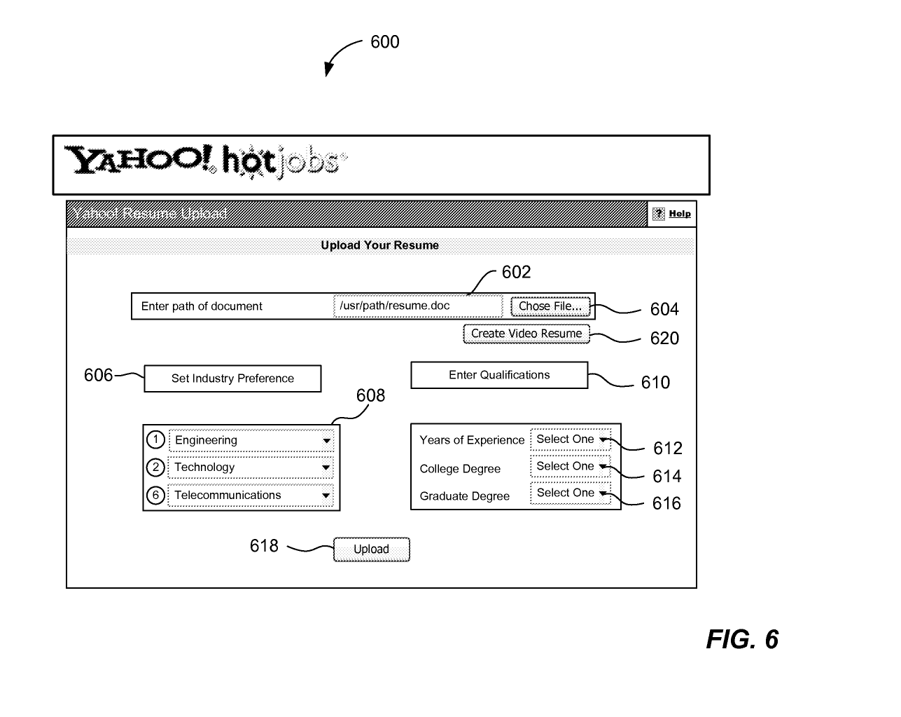

FIG. 6 depicts an exemplary user interface 600 for uploading a resume according to one embodiment. A jobseeker can upload his or her resume through a website of the job listing service provider 120. The jobseeker can further enter an associated video resume to be associated with the uploaded text resume.

A jobseeker can enter the file path of the location of a digital document that corresponds to the jobseeker's resume in a text field 602. In one example, the jobseeker can choose the file path by selecting a button 604 to browse the contents of one or more data storage devices associated with the jobseeker computing device 102.

Once the file path of the resume is entered by the jobseeker, the jobseeker can explicitly indicate jobseeker's preferences and/or qualifications. For example, the jobseeker can enter an industry preference using one or more dropdown menus 608. The jobseeker can indicate that the first preference for an industry that the jobseeker would like to work in is “Engineering.” As a second level preference the jobseeker can select “Technology.” In addition, as the third industry the jobseeker can select “Telecommunications” as the third industry of preference. In one example, these preferred industries can be saved as part of the jobseeker profile. In another example, these preferred industries can be saved on the jobseeker computing device 102.

In one embodiment, jobseeker explicit selections utilizing for example weights or scores that would indicate the jobseeker preferences for these industries and the corresponding scores. As such, when the jobseeker later searches for job listings, the relevance engine 110 can utilize the industry scores to further refine the job listing that would be more appropriate and relevant to the jobseeker.

In another example, the jobseeker can enter qualifications. For example, the jobseeker can enter the years of experience of the jobseeker in a drop down box 612. In another example, the jobseeker can enter the bachelor's degree received by the jobseeker in a drop down box 614. In another example, the jobseeker can enter the graduate degree received by the jobseeker in a drop down box 616.

In one embodiment, a button 620 can be provided for the jobseeker to select to upload and/or create a video resume to be associated with the text resume being uploaded.

Upon receiving a command to upload the resume, and the entered preferences and qualifications, the search engine 108 can be configured to parse the text in the resume. The text in the resume can further be utilized by the search engine 108 and the relevance module 107 in order to associate section of the video resume of the jobseeker to portions of the text resume.

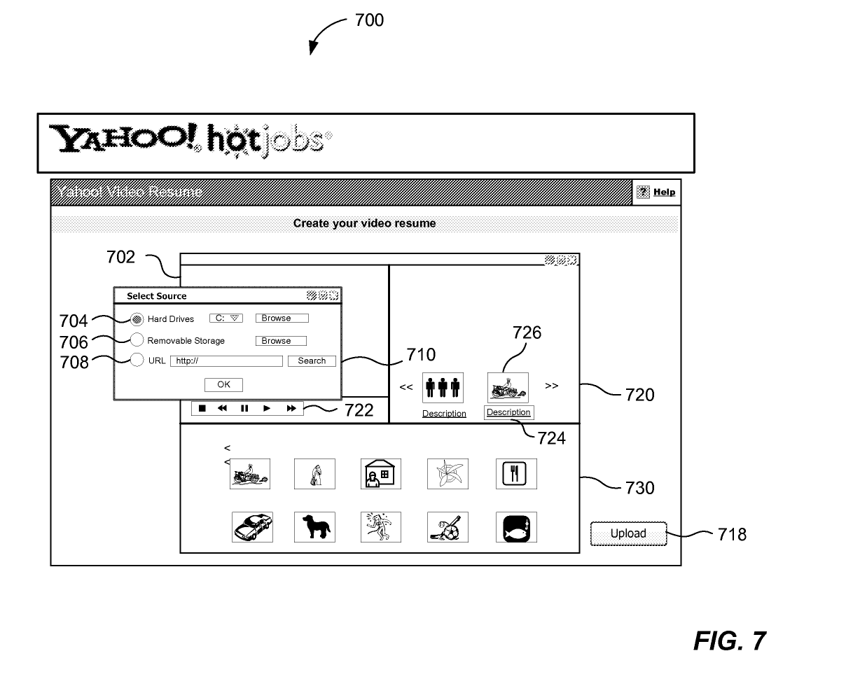

FIG. 7 depicts an exemplary user interface for creating a video resume according to one embodiment. User interface 700 includes a display area 702 wherein the video resume being edited can be previewed. In addition, the set of control buttons 722 can also be included in associated with the display area 702. The control buttons can permit a jobseeker editing the video to fast-forward, rewind, pause, play or stop. In addition, the control buttons can also allow a jobseeker that is editing the video resume to skip forward from one section to another. In addition, the control buttons can also allow the jobseeker creating the video resume to go backwards from one section to another.

The user interface 700 can also include an editing area that permits a jobseeker to create the video resume in accordance with the video resume template. For example, the editing area can include a sequence pane 720 and a pane 703. The sequence pane 720 can be utilized by the jobseeker to place one or more video clips on a specific order in the video resume. As such, the jobseeker can select one or more video clips using the thumbnails displayed in the pane 730 and drag a desired video clip to the sequence pane 720. Furthermore, the sequence pane 720 can also allow a jobseeker to select to describe each of the video clips that are added to the video resume in order to associate the video clip with a tag, keywords, or specific section of the text resume of the jobseeker. As one or more video clips are added together in the sequence pane 720, each video clip added can become a section of the video resume. Thus, as part of the description information that a jobseeker enters, the jobseeker can also provide a title for each specific section according to the content of the video clip. In one embodiment, a button 724 can be provided in order to select to describe or enter specific metadata for video clip 726.

In one embodiment, the video clips that the jobseeker uses in order to edit the video resume can be selected from various sources. To that end, a selection mechanism can be provided to the jobseeker. For example, the user can select among radio buttons 704, 706 and 708 to select the source for the various video clips. For example, the jobseeker can select the radio button 704 to select a hard drive. In addition, the user can select a radio button 706 to select a removable storage device. In another example, the user can select the radio button 708 to select a URL at which the specific video clip is located.

Various other user interfaces and logic as explained in connection with the video process module 114 can be provided to the jobseeker in order to create, edit or modify the video resume according to known, or to become known, techniques in the video editing and producing arts.

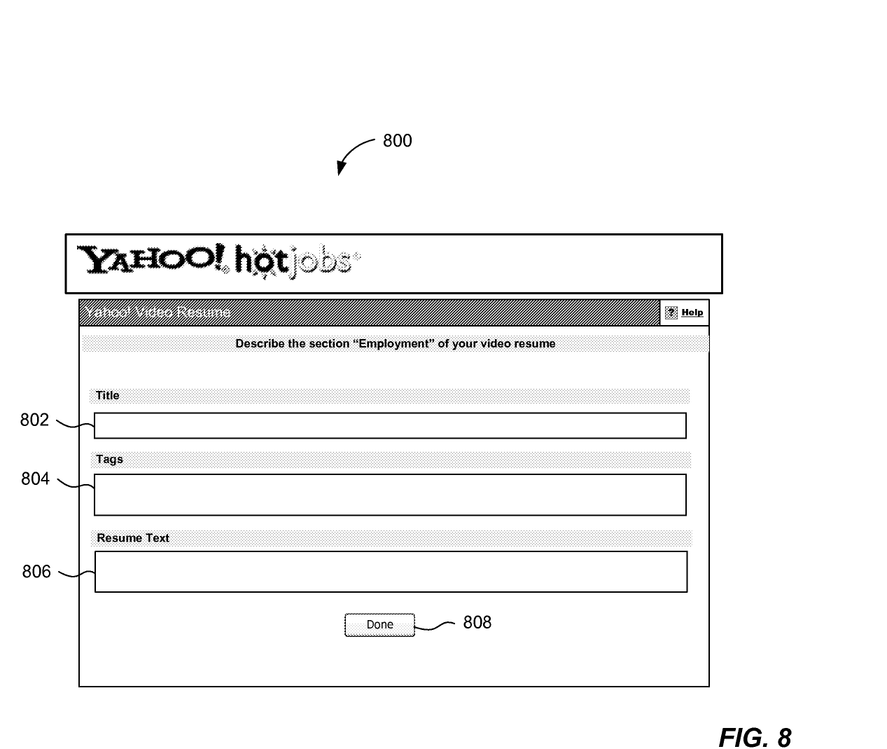

FIG. 8 depicts an exemplary user interface for entering metadata information associated to a video resume according to one embodiment. User interface 800 can include a text field 808 that allows a jobseeker to describe a video section by entering a title for the video section. Furthermore, a tags field 804 can be provided such that the jobseeker can enter tags associated with the video section being described. Furthermore, a resume tags field 806 can also be provided in order to permit the jobseeker to enter a portion of the text of a text resume that corresponds to the video clip being described. For example, if the video clip being described relates to the education of the jobseeker, the jobseeker can paste the resume text of the “Education” section on the resume text field 806 in order to associate the “Education” section of the video resume with the text that is pasted on the resume text field 806. Once the jobseeker is finished entering description information for the video clip of a video resume section, the user can enter or click on a button 808 in order to finalize the description of the video resume section and resume the creation or editing of the video resume.

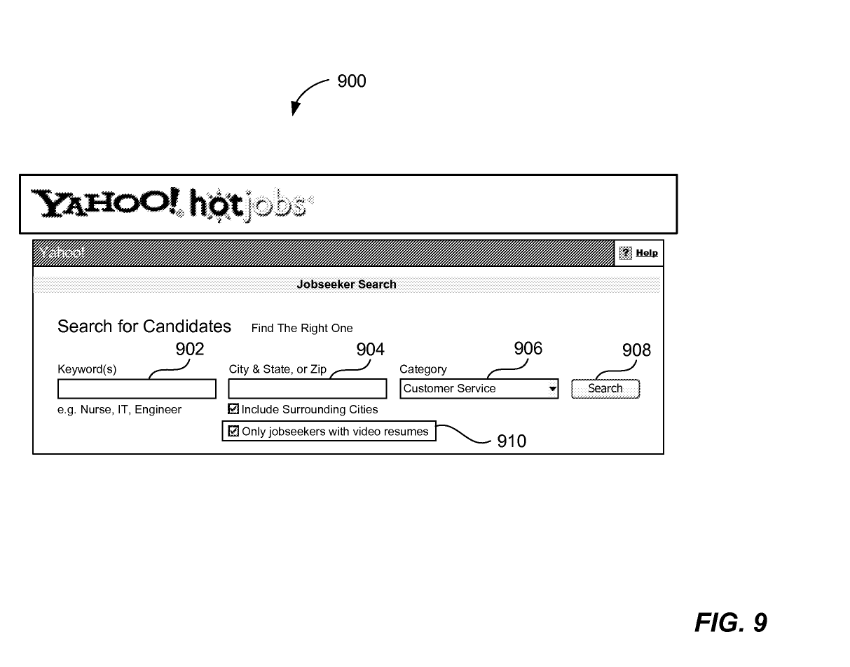

FIG. 9 depicts an exemplary user interface for permitting a recruiter to enter and submit a search for jobseekers according to one embodiment. User interface 900 includes text fields 902 and 904 that a recruiter can utilize to enter searching criteria. For example, in text field 902 a recruiter can enter keywords that can be utilized to locate jobseekers that have profile metadata associated with such keywords. In another example, in text field 902 a recruiter can enter keywords that can be utilized to locate jobseekers that have metadata associated with each jobseeker's video resume that matches the entered keywords. In addition, the recruiter can also enter city, state or zip code as well as selecting whether surrounding cities can be included at text field 904.

Furthermore, user interface 900 can also include a drop down menu 906 that would permit a recruiter to enter a category of the jobseeker. The category of the jobseeker can be categories in which the jobseeker has indicated to possess skills, expertise, certification, etc. Examples of categories can include customer service, technology, legal, entertainment, sales, etc. In addition, a search button 908 can be also provided in order to execute a search.

As previously discussed, the search engine 108 can utilize searched words entered by the recruiter to retrieve jobseekers from the jobseekers profiles database 116, or from the video resume database 120. Thus, keywords entered into text field 902, as well as the location entered in 904, and job industries or categories located in 906, can be utilized as part of the search of the jobseekers profile database 116. If for example the recruiter enters the keywords “software” and “engineer” in text field 902, the job listings provided would include any job listing that has as part of the title or metadata associated with the job listing the words engineer and software.

In addition, a recruiter can request that the search be limited to jobseekers who have submitted a video resume. For example, the user interface 900 can include a checkbox 910 that can permit the recruiter to select to only view a list of jobseekers who have submitted video resumes.

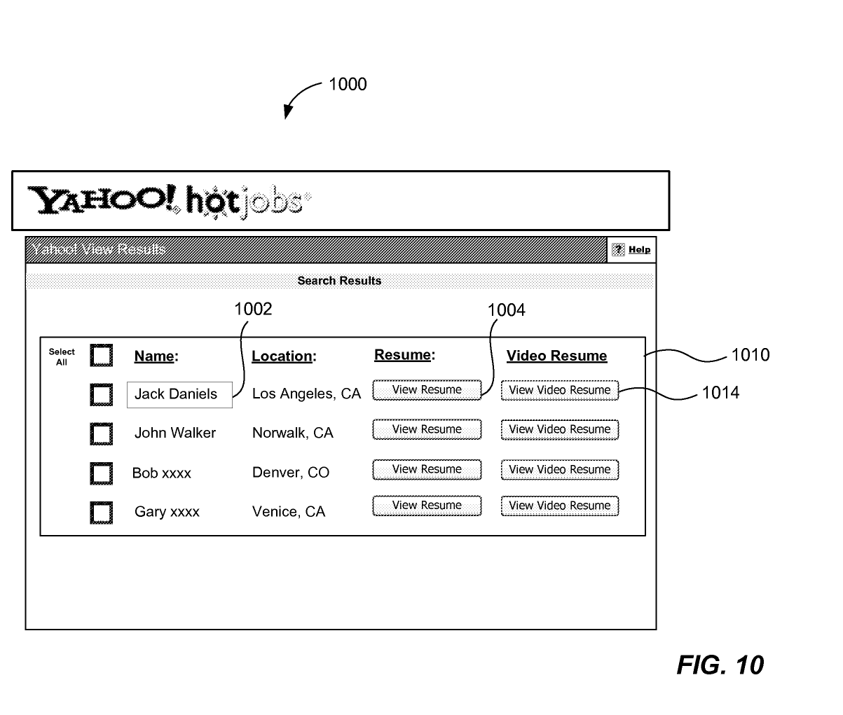

FIG. 10 depicts an exemplary user interface for listing jobseekers resulting from a search according to one embodiment. A listing 1010 can be displayed listing the search results from a query entered by a recruiter. The listing 1010 can correspond to list of jobseekers that have tags and keywords, associated with the jobseeker profile or video resume, that match the search query entered by the recruiter.

If the recruiter decides that the jobseeker corresponding to listing 1002 is a jobseeker that the recruiter would like to interview, or at least contact, the recruiter can select button 1004 in order to view the resume and parse through the qualifications of the jobseeker corresponding to listing 1002. In another example, the recruiter select the view video resume button 1014 in order to view a playback of the video resume of the jobseeker. In one embodiment, the video resume can be provided to recruiters who pay an additional fee to view the video resume.

In another embodiment, the recruiter can automatically receive lists of jobseekers who have submitted video resumes in connection with jobs posted by the recruiter. In one embodiment, the recruiter can receive an email alerting the recruiter that a jobseeker has applied for the job associated with a job posting of the recruiter. In another embodiment, the job listing service provider 120 permits the recruiter to visit a web page that lists all the job postings of the recruiter as well as associated listings of video resumes of jobseekers for each job posting.

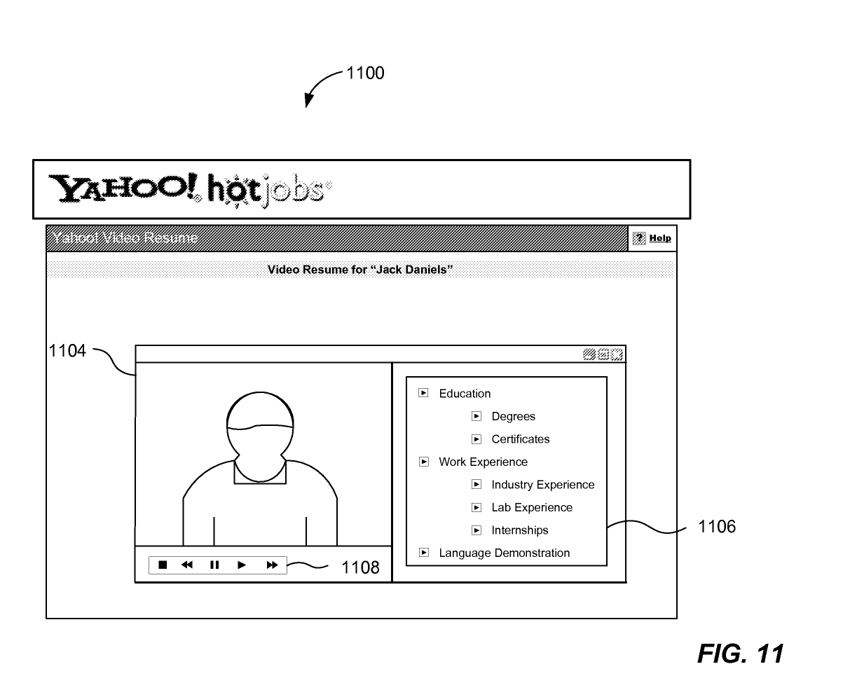

FIG. 11 depicts an exemplary user interface for displaying a video resume according to one embodiment. Once a recruiter selects to view the video resume of a jobseeker, the user interface 1100 can be displayed for the recruiter's viewing. In one embodiment, a display area 1104 can be provided in order to display digital video. Furthermore, a control console 1108 can be utilized and displayed as a user interface in conjunction with the display area 1104. The control console 1108 can include video control buttons such as stop, rewind, pause, play, fast forward, skip, etc. In addition, a menu 1106 can be displayed such that the recruiter can select specific sections of the video resume that the recruiter would like to view. As shown in menu 1106, playback buttons can be displayed along with each of the sections of the video resume. In one example, the video resume can include an education section with a degrees and certificates subsection. As another example, a Work Experience section and a Language Demonstration section can also be included as sections of the video resume. Thus, if the recruiter would like to view the Language Demonstration section of the video resume, the recruiter could simply select the playback button next to the Language Demonstration menu item and view the language demonstration of the jobseeker. Furthermore, the user interface 1100 can be configured such that additional text can be displayed in conjunction with a specific section. For example, if the section Education, in menu 1106 is selected by the recruiter, the video section of the video resume can play on the display area 1104. During the playback of the Education section, a display of the text of the resume of the jobseeker can be displayed on the display area 1104 as close-captioned text. Alternatively, upon the recruiter hovering over the menu item “Education,” the user interface 1100 can display the text in the form of a text cloud that can be visible to the recruiter. In other embodiments, the metadata text keywords and any other text information can be displayed in various user interface mechanisms now known in the art, or to become known in the art, in association with specific sections of a jobseeker's video resume.

Those skilled in the art will recognize that the methods and systems of the present disclosure may be implemented in many manners and as such are not to be limited by the foregoing exemplary embodiments and examples. In other words, functional elements being performed by a single or multiple components, in various combinations of hardware and software or firmware, and individual functions, can be distributed among software applications at either the client or server level or both. In this regard, any number of the features of the different embodiments described herein may be combined into single or multiple embodiments, and alternate embodiments having fewer than or more than all of the features herein described are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, and those variations and modifications that may be made to the hardware or software or firmware components described herein as would be understood by those skilled in the art now and hereafter.

1. A method of providing a video resume, comprising:
receiving from a recruiter an indication of a video resume template that is preferred by the recruiter, the video resume template being indicative of at least one required characteristic to be present in the video resume;
receiving a video resume from a jobseeker, the video resume being formatted in accordance with the video resume template; and
providing the video resume to the recruiter.

2. The method of claim 1, further comprising receiving metadata to be associated with at least one section of the video resume.

3. The method of claim 1, wherein the metadata describes content of the at least one section of the video resume.

4. The method of claim 1, wherein the metadata comprises associated text extracted from a resume of the jobseeker.

5. The method of claim 1, wherein the required characteristic to be present in the video resume is a video section in which the jobseeker answers a question posed by the recruiter.

6. The method of claim 1, wherein the required characteristic to be present in the video resume is a video section in which the jobseeker describes work experience.

7. (canceled)

8. The method of claim 1, wherein the required characteristic is the length of time of a specific section of the video resume.

9. The method of claim 1, further comprising creating a hyperlink in a text resume of the jobseeker, the hyperlink referencing a section of the video resume.

10. A system for providing a video resume, comprising:
a user interface module that receives from a recruiter an indication of a video resume template that is preferred by the recruiter, the video resume template being indicative of at least one required characteristic to be present in the video resume;
a video processing module that receives a video resume from a jobseeker, the video resume being formatted in accordance with the video resume template; and
a video rendering module that provides the video resume to the recruiter.

11. The system of claim 10, wherein the user interface module is configured to receive metadata to be associated with at least one section of the video resume.

12. The system of claim 10, wherein the metadata describes content of the at least one section of the video resume.

13. The system of claim 10, wherein the metadata comprises associated text extracted from a resume of the jobseeker.

14. The system of claim 10, wherein the required characteristic to be present in the video resume is a video section in which the jobseeker answers a question posed by the recruiter.

15. The system of claim 10, wherein the required characteristic to be present in the video resume is a video section in which the jobseeker describes work experience.

16. (canceled)

17. The system of claim 10, wherein the required characteristic is the length of time of a specific section of the video resume.

18. A method of providing a video resume, comprising:
receiving from a jobseeker a video resume that includes one or more sections, wherein each of the sections of the video resume contains metadata indicative of the content of the each of the sections; and
posting the video resume on a searchable database on a network, the searchable database being searchable by recruiters.

19. A method of receiving a video resume, comprising:
receiving from a jobseeker an indication that the jobseeker wants to provide a video resume in connection with a job listing posted by a recruiter;
providing to the jobseeker an indication of a video resume template that is preferred by the recruiter, the video resume template being indicative of at least one required characteristic to be present in the video resume;
receiving one or more video clips from the jobseeker;
receiving input from the jobseeker to order and format the one or more video clips so as to create the video resume in a manner such that the video resume is formatted in accordance with the video resume template; and
posting the video resume on a website in association with the job listing such that the recruiter can view the video resume through a computer network.

20. The method of claim 19, further comprising receiving metadata to be associated with at least one section of the video resume.

21. The method of claim 19, wherein the metadata describes content of the at least one section of the video resume.

22. The method of claim 19, wherein the metadata comprises associated text extracted from a resume of the jobseeker.

23. The method of claim 1, further comprising:
providing a user interface to a jobseeker, the user interface being configured to facilitate the creation of the video resume in accordance with the video resume template.

24. The method of claim 23, wherein providing the user interface includes providing a user interface mechanism to permit the jobseeker to enter metadata requested by the recruiter.

25. The method of claim 23, wherein providing the user interface includes providing a user interface mechanism to permit the jobseeker to answer a question posed by the recruiter.

26. The method of claim 23, wherein providing the user interface includes providing a user interface mechanism to permit the jobseeker to describe work experience.

27. (canceled)

28. A user interface for creating a video resume, comprising:
a selection mechanism that allows a jobseeker to indicate the source of one or more video clips to be included as part of the video resume;
an editing area that permits a jobseeker to create the video resume in accordance with a video resume template, and
a display area that permits a jobseeker to preview the video resume being created.
